(19) United States
(12) Patent Application Publication
(10) Pub. No.: US 2023/0128346 A1
(43) Pub. Date: Apr. 27, 2023

(54) METHOD, DEVICE, AND COMPUTER PROGRAM PRODUCT FOR TASK PROCESSING

(71) Applicant: EMC IP Holding Company LLC, Hopkinton, MA (US)

(72) Inventors: Jiacheng Ni, Shanghai (CN); Zijia Wang, WeiFang (CN); Zhen Jia, Shanghai (CN)

(21) Appl. No.: 17/526,621

(22) Filed: Nov. 15, 2021

(30) Foreign Application Priority Data
Oct. 21, 2021 (CN) 202111228257.9

(51) Int. Cl. G06N 3/04; G06F 9/48; G06N 3/08

(52) U.S. Cl. CPC G06N 3/0427; G06F 9/4843; G06N 3/0454; G06N 3/08

(57) ABSTRACT

Embodiments of the present disclosure relate to a method, an electronic device, and a computer program product for task processing. The method includes: processing, in response to receiving a target task, the target task by a first device using a deployed first model; acquiring a first result determined by the first model, the first result having a first confidence; processing, in response to determining that the first confidence is lower than a first threshold, the target task by a second device using a deployed second model; and acquiring a second result determined by the second model, the first model being constructed by compressing the second model. In this way, the accuracy of task processing can be ensured.

### RELATED APPLICATION(S)

The present application claims priority to Chinese Patent Application No. 202111228257.9, filed Oct. 21, 2021, and entitled “Method, Device, and Computer Program Product for Task Processing,” which is incorporated by reference herein in its entirety.

### FIELD

Embodiments of the present disclosure relate to the field of computers, and in particular, to a method, a device, and a computer program product for task processing.

### BACKGROUND

With the development of computer technologies, machine learning technology has been gradually applied to various aspects of people's lives. Computing devices may perform a wide variety of tasks using machine learning models.

In recent years, in order to improve the accuracy of model processing, the complexity of machine learning models is increasingly high, which leads to higher and higher demands for computing resources. For example, some relatively complex models may be difficult to deploy into devices with limited computing resources, such as mobile devices. Thus, it is difficult for people to achieve a balance between model processing accuracy and model processing efficiency.

### SUMMARY

A solution for task processing is provided in embodiments of the present disclosure.

According to a first aspect of the present disclosure, a method for task processing is provided. The method includes: processing, in response to receiving a target task, the target task by a first device using a deployed first model; acquiring a first result determined by the first model, the first result having a first confidence; processing, in response to determining that the first confidence is lower than a first threshold, the target task by a second device using a deployed second model; and acquiring a second result determined by the second model, the first model being constructed by compressing the second model.

According to a second aspect of the present disclosure, an electronic device is provided. The device includes: at least one processing unit; at least one memory coupled to the at least one processing unit and storing instructions for execution by the at least one processing unit, wherein the instructions, when executed by the at least one processing unit, cause the device to perform actions including: processing, in response to receiving a target task, the target task by a first device using a deployed first model; acquiring a first result determined by the first model, the first result having a first confidence; processing, in response to determining that the first confidence is lower than a first threshold, the target task by a second device using a deployed second model; and acquiring a second result determined by the second model, the first model being constructed by compressing the second model.

In a third aspect of the present disclosure, a computer program product is provided. The computer program product is stored in a non-transitory computer storage medium and includes machine-executable instructions that, when run in a device, cause the device to perform any step of the method described according to the first aspect of the present disclosure.

This Summary is provided to introduce the selection of concepts in a simplified form, which will be further described in the Detailed Description below. The Summary is neither intended to identify key features or essential features of the present disclosure, nor intended to limit the scope of the present disclosure.

### BRIEF DESCRIPTION OF THE DRAWINGS

By more detailed description of example embodiments of the present disclosure with reference to the accompanying drawings, the above and other objectives, features, and advantages of the present disclosure will become more apparent, where identical reference numerals generally represent identical components in the example embodiments of the present disclosure.

FIG. 1 shows a schematic diagram of an example system in which embodiments of the present disclosure may be implemented;

FIG. 2 shows a flow chart of a method for task processing according to some embodiments of the present disclosure;

FIG. 3 shows a flow chart of a method for task processing according to some other embodiments of the present disclosure; and

FIG. 4 shows a block diagram of an example device that may be configured to implement embodiments of the present disclosure.

### DETAILED DESCRIPTION

Example embodiments of the present disclosure will be described in more detail below with reference to the accompanying drawings. Although example embodiments of the present disclosure are illustrated in the accompanying drawings, it should be understood that the present disclosure may be implemented in various forms and should not be limited by the embodiments illustrated herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless otherwise stated, the term “or” means “and/or.” The term “based on” denotes “at least partially based on.” The terms “an example embodiment” and “an embodiment” denote “at least one example embodiment.” The term “another embodiment” means “at least one further embodiment.” The terms “first,” “second,” and the like may refer to different or the same objects. Other explicit and implicit definitions may also be included below.

As previously mentioned, it may be difficult to deploy complex machine learning models in some computing devices with limited computing resources (e.g., mobile terminals, edge terminal devices, etc.). Therefore, it is possible to compress complex models to further obtain simplified models having smaller sizes or smaller amounts of computation. However, though such simplified models enable computing devices with limited computing resources to have corresponding processing power, the processing accuracy of the simplified models may be affected, which may lead to undesirable errors in some task processing results.

A solution for task processing is provided in embodiments of the present disclosure. In this solution, when a target task is received, the target task may be processed by a first device using a deployed first model. Further, a first result determined by the first model may be acquired. The first result has a first confidence. When it is determined that the first confidence is lower than a first threshold, the target task may be processed by a second device using a deployed second model, and a second result determined by the second model may be acquired. The first model is constructed by compressing the second model.

In this way, according to embodiments of the present disclosure, when a processing result of a first model (which may be, for example, a simplified model) has a low confidence, a target task may be further processed by using a more complex model (which may be, for example, a more complex model) deployed on a second device having greater computing power, so that the accuracy of task processing can be ensured.

The solution of the present disclosure will be described below with reference to the accompanying drawings.

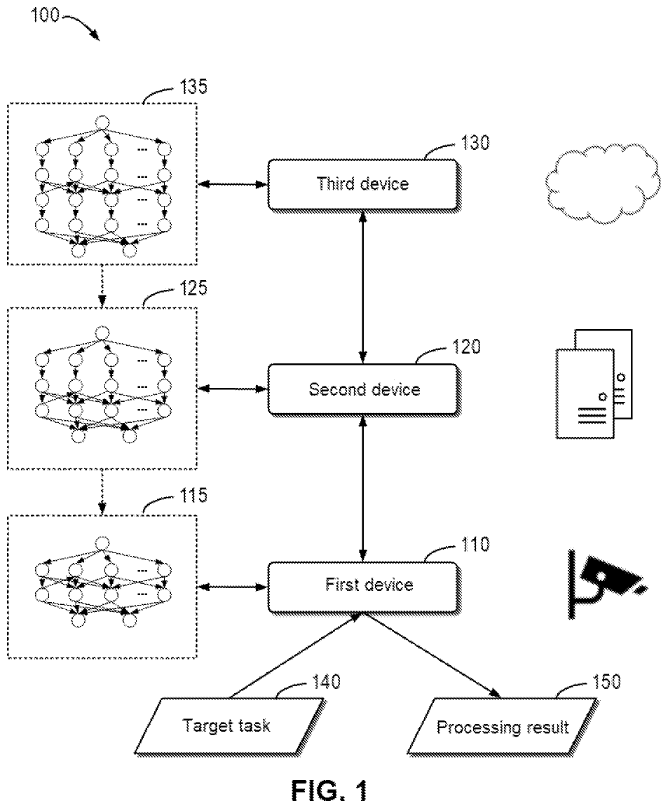

FIG. 1 shows example environment 100 in which embodiments of the present disclosure may be implemented. As shown in FIG. 1, environment 100 includes a plurality of computing devices, such as first device 110, second device 120, and third device 130. In some embodiments, first device 110, second device 120, and third device 130 may, for example, have different levels of computing power.

Illustratively, as shown in FIG. 1, first device 110 may be, for example, an edge terminal device in the Internet of Things, which may, for example, have relatively limited computing resources. Second device 120 may be, for example, an edge server device, which may, for example, have higher computing power than first device 110. Third device 130 may be, for example, a cloud server device, which may, for example, have the highest level of computing power.

In some embodiments, as shown in FIG. 1, in order to utilize computing devices with different levels of computing power, models with different complexities may be deployed into various computing devices respectively. Illustratively, first device 110 may be provided, for example, with first model 115, second device 120 may be provided, for example, with second model 125, and third device 130 may be provided, for example, with third model 135.

Examples of the model (including first model 115, second model 125, and/or third model 135) in the present disclosure include, but are not limited to, various types of deep neural networks (DNN), convolutional neural networks (CNN), support vector machines (SVM), decision trees, random forest models, etc. In implementations of the present disclosure, a prediction model may also be referred to as a “machine learning model.” The terms “prediction model,” “neural network,” “learning model,” “learning network,” “model,” and “network” may be used interchangeably below.

In some embodiments, first model 115, second model 125, and third model 135 may be, for example, used to perform the same machine learning task and have different levels of model complexity. As shown in FIG. 1, first model 115 may, for example, have a low model complexity, and third model 135 may, for example, have the highest model complexity.

In some embodiments, as will be described in detail below, third model 135 may be, for example, constructed directly based on training data. Second model 125 may be obtained, for example, by compressing third model 135. Further, the first model 115 may be obtained, for example, by compressing second model 125.

In some embodiments, model compression may represent a process that reduces the complexity of a model structure or reduces the amount of computation of a model. Typical model compression may include, for example, knowledge distillation, model pruning, or model quantization.

As will be described in detail below, first device 110, second device 120, and/or third device 130 may be configured to cooperatively process target task 140 to determine processing result 150 for target task 140.

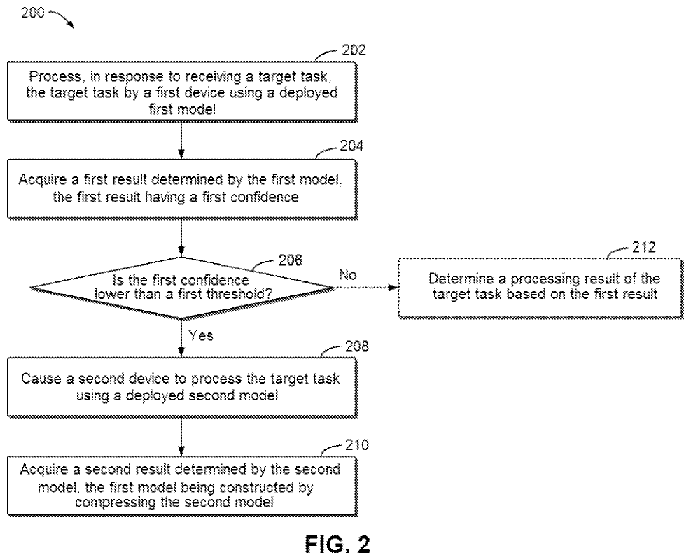

FIG. 2 is a flow chart of process 200 for task processing according to some embodiments of the present disclosure. Process 200 may be implemented, for example, by first device 110 shown in FIG. 1.

As shown in FIG. 2, at block 202, in response to receiving target task 140, first device 110 processes target task 140 using deployed first model 115.

In some embodiments, first model 115 may be, for example, a model for performing a classification task on samples. Such samples may include, for example, any suitable type of samples, such as text, images, video, or audio.

In some embodiments, target task 140 may include a target sample to be processed. Accordingly, the target sample may be provided to first model 115 to perform a corresponding machine learning task.

At block 204, first device 110 acquires a first result determined by first model 115. The first result has a first confidence. In some embodiments, the first confidence may indicate a degree of reliability of the first result.

In some embodiments, the first result may be, for example, a classification result for the target sample determined by first model 115. Additionally, first model 115 may also determine a first confidence of the first result.

In some embodiments, first model 115 may be, for example, a classification model. Specifically, first device 110 may process the target task using first model 115 to determine a set of classification probabilities corresponding to a set of classification tags. Further, first device 110 may determine the first confidence of the first result based on the set of classification probabilities.

In some embodiments, first device 110 may determine the first confidence using an information entropy. Specifically, first device 110 may determine an information entropy of a set of classification probabilities and further determine a first confidence based on the information entropy.

In some embodiments, if the classification probabilities of the first model for the plurality of classification tags are relatively even, the set of classification probabilities corresponds to a relatively large information entropy, indicating that the first model has a high uncertainty for the first result. Accordingly, the first confidence may be determined to have a low value.

Conversely, if the distribution of the classification probabilities is more centralized, for example, when it is close to a One-Hot distribution (i.e., one classification probability is 1, and the others are 0), the set of classification probabilities has a small information entropy, indicating that the first model has a low uncertainty for the first result. Accordingly, the first confidence may be determined to have a high value.

In some embodiments, the first confidence may also be determined using other suitable metrics, such as a Bayesian Active Learning by Disagreement (BALD).

At block 206, first device 110 determines whether the first confidence is lower than a first threshold. If first device 110 determines that the first confidence is greater than or equal to the first threshold, process 200 may proceed to block 212. At block 212, first device 110 may determine processing result 150 of target task 140 based on the first result.

If it is determined at block 206 that the first confidence is lower than the first threshold, process 200 may proceed to block 208. At block 208, first device 110 causes second device 120 to process the target task using deployed second model 125.

In some embodiments, for a three-level computing device architecture shown in FIG. 1, second device 120 may be, for example, an intermediate-level computing device, such as an edge server device. In some embodiments, the environment may include, for example, only two levels of computing devices, and accordingly, second device 120 may also be, for example, a cloud server computing device.

Specifically, first device 110 may send, for example, data associated with target task 140 to second device 120 through wired or wireless communication. For example, first device 110 may send a target sample to be processed to second device 120.

At block 210, first device 110 acquires a second result determined by second model 125, where first model 115 is constructed by compressing second model 125.

Specifically, second device 120 may process the target task using second model 125, determine a second result for the target task, and send the second result to first device 110.

In some embodiments, first model 115 may be, for example, obtained by performing model compression on second model 125. For example, model compression may include, but is not limited to: knowledge distillation, model pruning, or model quantization.

The knowledge distillation refers to a process of transferring knowledge from a large model (teacher model) to a small model (student model). Although large models (e.g., very deep neural networks or integration of many models) have a higher knowledge capacity than small models, such capacity may not be fully utilized. Knowledge distillation can transfer knowledge from a large model to a small model without loss of effectiveness. Small models may be deployed on less functional hardware (e.g., mobile devices) due to their low computing cost.

Model pruning refers to removing redundant connections present in a model architecture to delete channels in the model architecture that have, for example, a low degree of importance. In this way, the size of a model and the amount of computation may be reduced.

Quantization involves bundling weights together by clustering or rounding the weights so that less memory may be used to represent the same number of connections. Quantization to represent more features by clustering/bundling and thus using a smaller number of different floating-point values is one of the most common techniques. Another quantization technique may convert floating point weights to fixed point representations by rounding. In this way, the storage overhead or computing overhead of a model can be reduced.

Further, first device 110 may determine processing result 150 for target task 140 based on the received second result.

Since second model 125 deployed in second device 120 has a higher model complexity, a more accurate processing result can be obtained. Therefore, when the confidence of a result determined by the first model is low, embodiments of the present disclosure may further invoke a second model of a higher model complexity to improve the progress of task processing.

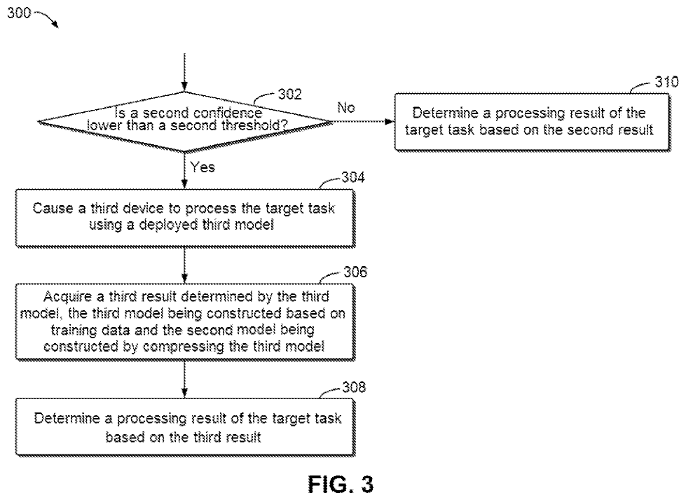

In some embodiments, it may be further determined according to the second confidence of the second result whether a third device needs to be invoked to process the target task. FIG. 3 is a flow chart of process 300 for task processing according to some embodiments of the present disclosure. Process 300 may be implemented, for example, by first device 110 and/or second device 120 shown in FIG. 1.

As shown in FIG. 3, at block 302, it may be determined whether the second confidence is lower than a second threshold. It should be understood that second model 125 may determine the second confidence of the second result based on a process similar to determining the first confidence.

In some embodiments, a comparison process of block 302 may be performed, for example, by second device 120, and upon determining that the second confidence is not lower than the second threshold, second device 120 may send the second result to first device 110. Accordingly, the process may proceed to block 310 where processing result 150 for target task 140 may be determined by first device 110 based on the received second result.

Conversely, if it is determined at block 302 that the second confidence is lower than the second threshold, second device 120 may cause third device 130 to process target task 140 using deployed third model 135 at block 304. Illustratively, second device 120 may send data of the target sample to third device 130. Accordingly, the second device may, for example, not return the determined second result to first device 110.

In some embodiments, a comparison process of block 302 may also be performed, for example, by first device 110. Accordingly, second device 120 may, for example, always send the second result and the second confidence to first device 110, and first device 110 may determine whether the second confidence is lower than the second threshold.

If it is determined at block 302 that the second confidence is lower than the second threshold, for example, first device 110 may cause third device 130 to process target task 140 using deployed third model 135. Illustratively, first device 110 may send data of the target sample to third device 130.

At block 306, first device 110 may acquire a third result determined by third model 135, where third model 135 is constructed based on training data and second model 125 is constructed by compressing third model 135.

In some embodiments, the third result may be received directly from third device 130 by, for example, first device 110. Or, the third result may be received by second device 120 from third device 130 and forwarded to first device 110.

At block 308, processing result 150 of the target task 140 is determined based on the third result.

In some embodiments, as discussed above with reference to FIG. 1, first device 110 may be an edge terminal device, second device 120 may be an edge server device, and third device 130 may be a cloud server device.

In addition, for the above architecture in the Internet of Things, different models respectively deployed to the edge terminal device, the edge server device, and the cloud server device may be constructed in the following manner.

In some embodiments, third model 135 may be constructed based on training data, which may, for example, have a large model size. Further, second model 125 and first model 115 may be constructed respectively based on a Teacher-Assistant knowledge distillation process.

Specifically, directly distilling third model 135 to, for example, first model 115 having the smallest size may greatly affect the accuracy of the model. Therefore, a knowledge distillation process may be first utilized to distill third model 135 to second model 125 having a medium scale.

Further, second model 125 may be further subjected to knowledge distillation to obtain an intermediate model, and the intermediate model may be further adjusted to obtain first model 115.

In some embodiments, adjusting the intermediate model may include, for example, pruning the intermediate model. Alternatively or additionally, adjusting the intermediate model may also include quantizing the intermediate model, for example, adjusting a floating point number of 32-bit precision to a floating point number of 16-bit precision.

Based on such a process, embodiments of the present disclosure are able to respectively deploy multi-level models of different scales into computing devices having different computing power in the Internet of Things, so that the computing power of different computing devices in the Internet of Things can be fully utilized. In addition, embodiments of the present disclosure can also ensure the accuracy of task processing through multi-level model processing.

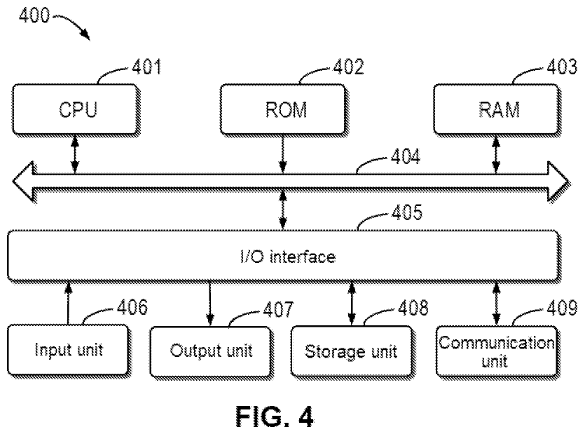

FIG. 4 shows a schematic block diagram of example device 400 that may be configured to implement embodiments of the present disclosure. For example, first device 110, second device 120, and/or third device 130 according to embodiments of the present disclosure may be implemented by device 400. As shown in the figure, device 400 includes central processing unit (CPU) 401 that may execute various appropriate actions and processing according to computer program instructions stored in read-only memory (ROM) 402 or computer program instructions loaded from storage unit 408 to random access memory (RAM) 403. RAM 403 may further store various programs and data required by operations of device 400. CPU 401, ROM 402, and RAM 403 are connected to each other through bus 404. Input/output (I/O) interface 405 is also connected to bus 404.

A number of components in device 400 are connected to I/O interface 405, including: an input unit 406, such as a keyboard and a mouse; an output unit 407, such as various types of displays and speakers; a storage unit 408, such as a magnetic disk and an optical disc; and communication unit 409, such as a network card, a modem, or a wireless communication transceiver. Communication unit 409 allows device 400 to exchange information/data with other devices through a computer network such as the Internet and/or various telecommunication networks.

Various processes and processing described above, for example, processes 200 and/or 300, may be performed by CPU 401. For example, in some embodiments, processes 200 and/or 300 may be implemented as computer software programs that are tangibly included in a machine-readable medium, for example, storage unit 408. In some embodiments, part of or all the computer programs may be loaded and/or installed onto device 400 via ROM 402 and/or communication unit 409. When the computer programs are loaded into RAM 403 and executed by CPU 401, one or more actions of processes 200 and/or 300 described above may be performed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming language such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described here with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented using a combination of special hardware and computer instructions.

Various implementations of the present disclosure have been described above. The foregoing description is illustrative rather than exhaustive, and is not limited to the disclosed implementations. Numerous modifications and alterations will be apparent to persons of ordinary skill in the art without departing from the scope and spirit of the illustrated implementations. The selection of terms used herein is intended to best explain the principles and practical applications of the implementations or the improvements to technologies on the market, so as to enable persons of ordinary skill in the art to understand the implementations disclosed herein.

What is claimed is:

1. A method for task processing, comprising:
processing, in response to receiving a target task, the target task by a first device using a deployed first model;
acquiring a first result determined by the first model, the first result having a first confidence;
processing, in response to determining that the first confidence is lower than a first threshold, the target task by a second device using a deployed second model; and
acquiring a second result determined by the second model, the first model being constructed by compressing the second model.

2. The method according to claim 1, further comprising:
determining a second confidence of the second result;
processing, in response to determining that the second confidence is lower than a second threshold, the target task by a third device using a deployed third model; and
acquiring a third result determined by the third model, the third model being constructed based on training data and the second model being constructed by compressing the third model.

3. The method according to claim 2, wherein the first device is an edge terminal device, the second device is an edge server device, and the third device is a cloud server device.

4. The method according to claim 2, wherein the second model is obtained by knowledge distillation of the third model, and further wherein the first model is constructed based on the following process:
performing knowledge distillation on the second model to obtain an intermediate model; and
adjusting the intermediate model to obtain the first model.

5. The method according to claim 4, wherein adjusting the intermediate model comprises:
pruning the intermediate model; or
quantizing the intermediate model.

6. The method according to claim 1, wherein the first model is configured to perform a classification task, and the method further comprises:
processing, by the first model, the target task to determine a set of classification probabilities corresponding to a set of classification tags; and
determining the first confidence of the first result based on the set of classification probabilities.

7. The method according to claim 6, wherein determining the first confidence of the first result based on the set of classification probabilities comprises:
determining an information entropy of the set of classification probabilities; and
determining the first confidence based on the information entropy.

8. An electronic device, comprising:
at least one processing unit;
at least one memory coupled to the at least one processing unit and storing instructions for execution by the at least one processing unit, wherein the instructions, when executed by the at least one processing unit, cause the device to perform actions comprising:
processing, in response to receiving a target task, the target task by a first device using a deployed first model;
acquiring a first result determined by the first model, the first result having a first confidence;
processing, in response to determining that the first confidence is lower than a first threshold, the target task by a second device using a deployed second model; and
acquiring a second result determined by the second model, the first model being constructed by compressing the second model.

9. The electronic device according to claim 8, wherein the actions further comprise:
determining a second confidence of the second result;
processing, in response to determining that the second confidence is lower than a second threshold, the target task by a third device using a deployed third model; and
acquiring a third result determined by the third model, the third model being constructed based on training data and the second model being constructed by compressing the third model.

10. The electronic device according to claim 9, wherein the first device is an edge terminal device, the second device is an edge server device, and the third device is a cloud server device.

11. The electronic device according to claim 9, wherein the second model is obtained by knowledge distillation of the third model, and further wherein the first model is constructed based on the following process:
performing knowledge distillation on the second model to obtain an intermediate model; and
adjusting the intermediate model to obtain the first model.

12. The electronic device according to claim 11, wherein adjusting the intermediate model comprises:
pruning the intermediate model; or
adjusting a parameter accuracy of the intermediate model.

13. The electronic device according to claim 8, wherein the first model is configured to perform a classification task, and the actions further comprise:
processing, by the first model, the target task to determine a set of classification probabilities corresponding to a set of classification tags; and
determining the first confidence of the first result based on the set of classification probabilities.

14. The electronic device according to claim 13, wherein determining the first confidence of the first result based on the set of classification probabilities comprises:
determining an information entropy of the set of classification probabilities; and
determining the first confidence based on the information entropy.

15. A computer program product stored in a non-transitory computer storage medium and comprising machine-executable instructions that, when run in a device, cause the device to perform a method for task processing, comprising:
processing, in response to receiving a target task, the target task by a first device using a deployed first model;
acquiring a first result determined by the first model, the first result having a first confidence;
processing, in response to determining that the first confidence is lower than a first threshold, the target task by a second device using a deployed second model; and
acquiring a second result determined by the second model, the first model being constructed by compressing the second model.

16. The computer program product according to claim 15, further comprising:
determining a second confidence of the second result;
processing, in response to determining that the second confidence is lower than a second threshold, the target task by a third device using a deployed third model; and
acquiring a third result determined by the third model, the third model being constructed based on training data and the second model being constructed by compressing the third model.

17. The computer program product according to claim 16, wherein the first device is an edge terminal device, the second device is an edge server device, and the third device is a cloud server device.

18. The computer program product according to claim 16, wherein the second model is obtained by knowledge distillation of the third model, and further wherein the first model is constructed based on the following process:
performing knowledge distillation on the second model to obtain an intermediate model; and
adjusting the intermediate model to obtain the first model.

19. The computer program product according to claim 18, wherein adjusting the intermediate model comprises:
pruning the intermediate model; or
quantizing the intermediate model.

20. The computer program product according to claim 15, wherein the first model is configured to perform a classification task, and the method further comprises:
processing, by the first model, the target task to determine a set of classification probabilities corresponding to a set of classification tags; and
determining the first confidence of the first result based on the set of classification probabilities.
